(19) United States
(12) Patent Application Publication
(10) Pub. No.: US 2009/0300587 A1
(43) Pub. Date: Dec. 3, 2009

(54) DETERMINING DOMAIN DATA COVERAGE IN TESTING DATABASE APPLICATIONS

(75) Inventors: Eric Zheng, Shanghai (CN); Shu Zhang, Shanghai (CN); Tianxiang Chen, Shanghai (CN); Apple Zhu, Shanghai (CN); Jason Hong, Shanghai (CN); Junbo Zhang, Sammamish, WA (US); Marcelo Medeiros De Barros, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/127,009

(22) Filed: May 27, 2008

(51) Int. Cl. G06F 11/36

(52) U.S. Cl. 717/127

(57) ABSTRACT

Testing systems and methods are provided for determining domain data coverage of a test of a codebase. The testing system may include a coverage program having a setup module configured to receive user input indicative of a target domain data table to be monitored during the test. The coverage program may further include a test module configured to programmatically generate a shadow table configured to receive coverage data, and to create one or more triggers on the target domain data table. The triggers may be configured, upon firing, to make entries of coverage data in the shadow table indicating that the trigger was fired during the test. The coverage program may also include an output module configured to compare the shadow table and the target domain data table to produce a coverage result, and to display the coverage result via a graphical user interface.

### BACKGROUND

To test a software application prior to release, developers employ test programs that apply programmatic inputs to the software application, and measure the results. To ensure that the programmatic inputs of the test program adequately cover various aspects of the software application, the test program may track the execution of source code, such as C++, C#, and SQL stored procedures in the codebase of the software application while the test program is running.

However, in the context of testing online services that employ backend relational databases as well as front and/or middle tier applications, source code tracking may be inadequate. Unlike stand-alone software applications, such online services perform transactions involving many data elements stored in a backend database. The performance of the online service is dependent on the various possible values for each element, referred to as the “data domain” for each data element. However, source code tracking may fail to indicate whether the test has covered the full realm of possibilities in the data domain for each data element, because operations on data elements stored in the database may be handled generically by the same section of code in a front and/or middle tier application, irrespective of the different value or type of the data in the data element. Thus, tracking of source code coverage cannot be relied upon to provide accurate indication of domain data coverage when testing an online service. Untested aspects of an online service may result in unforeseen errors occurring after release, potentially resulting in undesirable downtime, lost revenues, and loss of goodwill with customers.

### SUMMARY

Testing systems and methods are provided for determining domain data coverage of a test of a codebase. The testing system may include a coverage program having a setup module configured to receive user input indicative of a target domain data table to be monitored during the test. The coverage program may further include a test module configured to programmatically generate a shadow table configured to receive coverage data, and to create one or more triggers on the target domain data table. The triggers may be configured, upon firing, to make entries of coverage data in the shadow table indicating that the trigger was fired during the test. The coverage program may also include an output module configured to compare the shadow table and the target domain data table to produce a coverage result, and to display the coverage result via a graphical user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view illustrating an embodiment of a system for determining domain data coverage of a test of a codebase.

FIG. 2 is a schematic view illustrating a foreign key dependency, trigger, and domain data table utilized by the system of FIG. 1.

FIG. 3 is a schematic view illustrating an instance of a domain data table that may be utilized by the system of FIG. 1.

FIG. 4 is a schematic view illustrating an instance of a shadow table that may be created by the system of FIG. 1.

FIG. 5 is a schematic view a graphical user interface of the system of FIG. 1, displaying a setup interface for receiving user input indicative of domain name data to be monitored, and a visualization interface configured to display a coverage result.

FIG. 6 is a flow diagram illustrating an embodiment of a method for determining domain data coverage of a test of a codebase.

### DETAILED DESCRIPTION

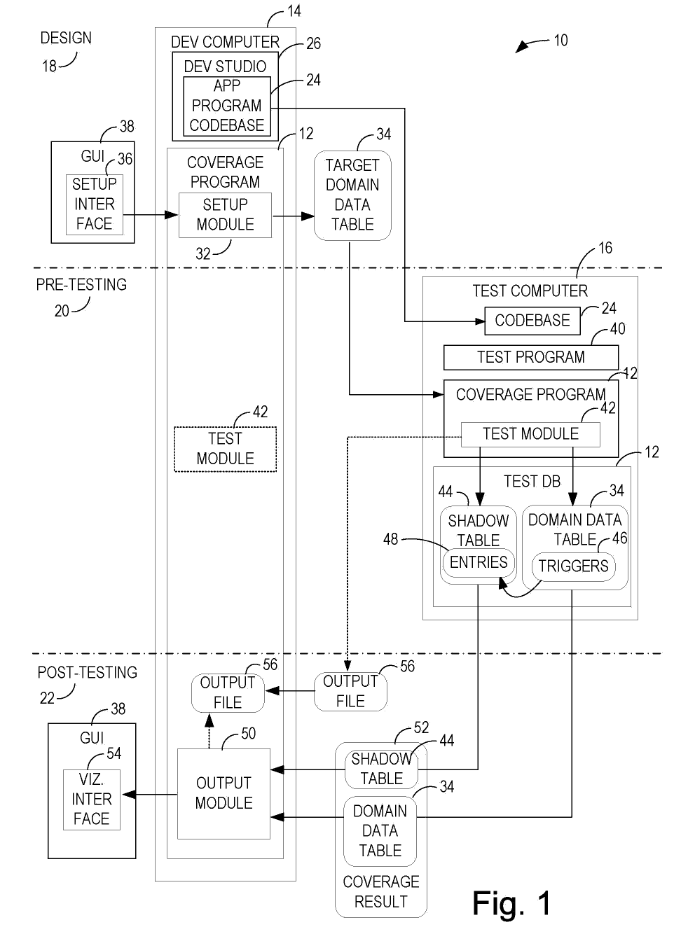

FIG. 1 illustrates a testing system 10 for determining domain data coverage of a test of a codebase that utilizes a relational database. The testing system 10 may include a coverage program 12 configured to be executed on a computing device, such as a development computer 14 or a test computer 16. The coverage program 12 may be utilized in a design phase 18, a pre-testing phase 20, and a post-testing phase 22. While the depicted embodiment illustrates the coverage program 12 implemented in three developments phases on two different computing devices, it will be appreciated that alternatively the coverage program 12 may be implemented on one or more computing devices, in a development cycle that incorporates more, fewer, or different development phases than those illustrated. Further, it will be appreciated that the coverage program may be implemented via code that is stored in the one or more computing devices.

In the design phase 18, a developer may program a codebase 24 on the development computer 14 using a development studio program 26. The codebase 24 may be for a software application or software component that interfaces with a relational database. Various data may be exchanged between the codebase 24 and the relational database during use, and the scope of possible values for this data may be referred to as a data domain for the application and database interaction.

Once the codebase 24 has been developed using the development studio program 26 and is ready for testing, the coverage program 12 may be used during the design phase 18 to receive user input of domain data to monitor for coverage scope during testing. For example, the coverage program 12 may include a setup module 32 that may be executed on the development computer 14 during the design phase 18. The setup module 32 may be configured to display a setup interface 36 on a graphical user interface 38 associated with the development computer 14. The setup module 32 may be configured to receive user input indicative of a target domain data table 34 of the relational database to be monitored during the test of the codebase 24, via the setup interface 36. The target domain data table 34 may include possible values for a data element utilized by the codebase and stored in the relational database.

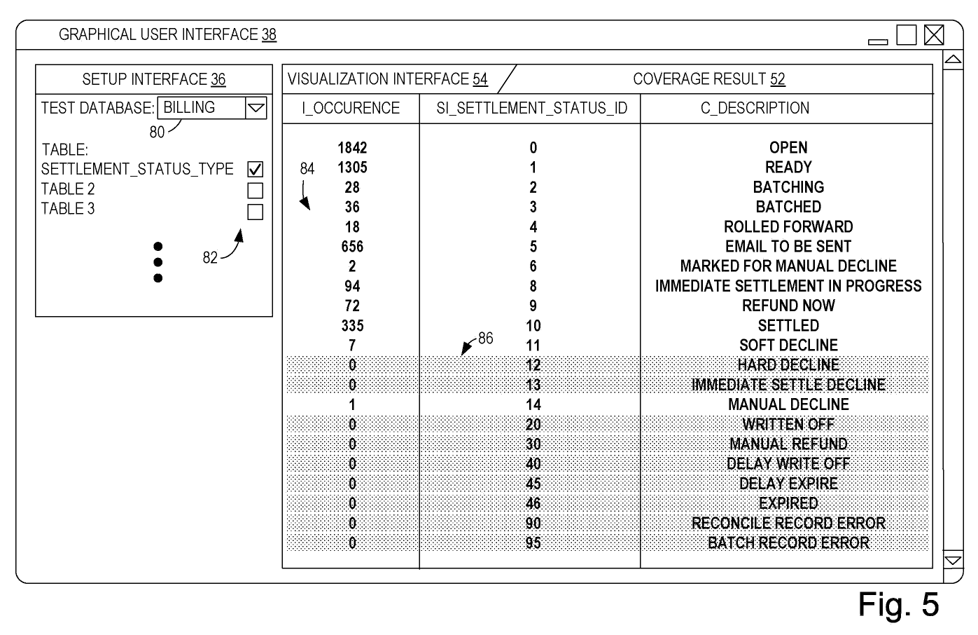

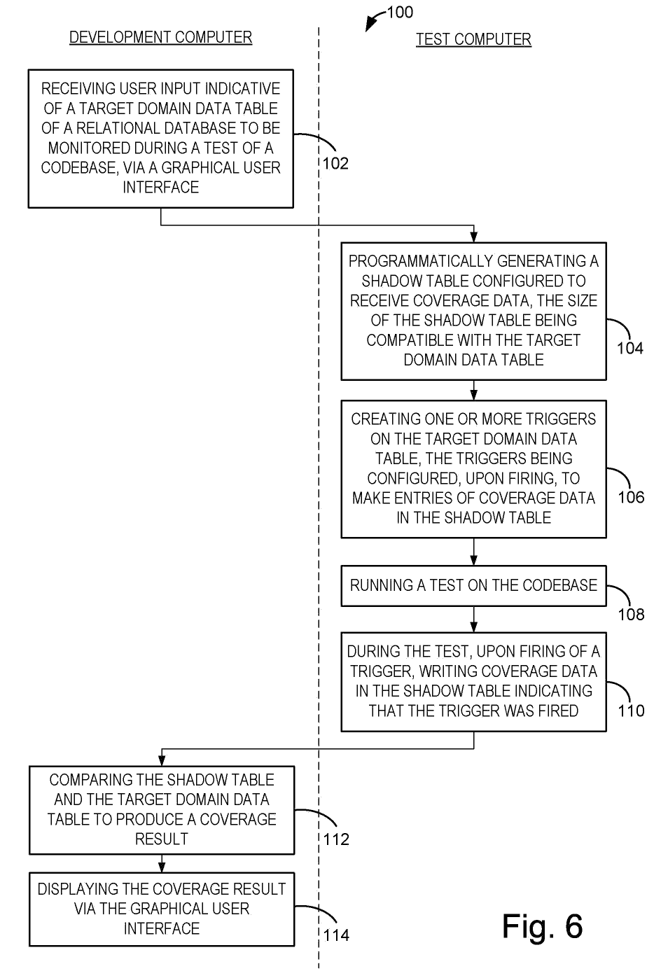

One example of such a setup interface 36 is illustrated in FIG. 5. As shown, the setup interface 36 may include a database selector 80 configured to enable a user to select one or more databases from which to select one or more target data domain table for coverage monitoring. The setup interface 36 may further include a table selector 82 configured to enable the user to select one or more target data domain tables from the one or more databases, for coverage monitoring.

Returning to FIG. 1, during the pre-testing phase 20, the codebase 24 may be transferred to a test computer 16, and readied for testing by a test program 40 executed on the test computer 16. During the test, the test program 40 will apply a test suite of tools and data to send programmatic inputs to the codebase, and measure the results.

The coverage program 12 may further include a test module 42 that may be executed on the test computer 16 during the pre-testing phase 20, and configured to determine whether the programmatic inputs of the test program 40 adequately cover various aspects of the software application. During the pre-testing phase, the test module 42 may be configured to programmatically generate a shadow table 44 configured to receive coverage data. The size of the shadow table 44 may be compatible with the target domain data table 34, to facilitate joinder of the data in the tables in downstream processing.

The test module 42 may also be configured to create one or more triggers 46 on the target domain data table. The triggers 46 are procedural code that is executed in response to a defined event on a particular table in a database. The triggers 46 may be configured, upon firing, to make entries 48 of coverage data in the shadow table 44 indicating that the trigger was fired during the test. Thus, triggers 46 provide a mechanism to determine coverage of the various discrete values in the target data domain table during the test. It will be appreciated that the generation of the shadow table and triggers occurs programmatically according to stored algorithms that operate upon the user input domain data table 34, as discussed below.

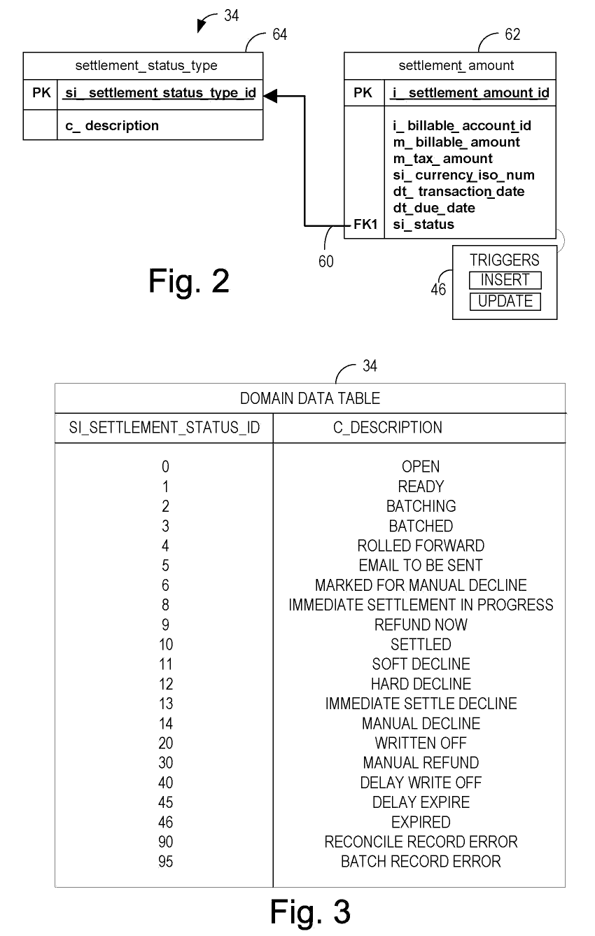

As illustrated in FIG. 2, to facilitate the creation of the shadow table and the triggers programmatically, the test module 42 may be configured to detect one or more foreign key dependencies 60 of the target domain data table. A foreign key dependency is a referential constraint between two tables in a relational database. In FIG. 2, the foreign key dependency 60 is illustrated referentially connecting the SI_STATUS data element of the SETTLEMENT_AMOUNT table 62, to the SETTLEMENT_STATUS_TYPE table 64. Since the SETTLEMENT_STATUS_TYPE table 64 contains the possible values for the SI_STATUS data element, it will be appreciated that the SETTLEMENT_STATUS_TYPE table 64 functions as a domain data table 34 for the SI_STATUS data element.

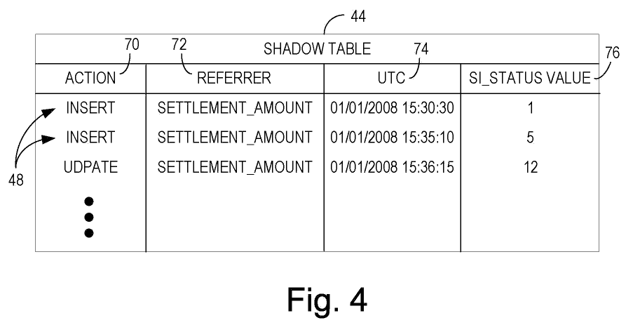

FIG. 3 illustrates one particular instance of a domain data table 34, showing all possible values of C_DESCRIPTION and SI_SETTLEMENT_STATUS_ID for the SI_STATUS data element. FIG. 4 illustrates one particular instance of a shadow table 44, including a plurality of entries, each entry including an action 70 to be performed by the trigger, a referring table 72 containing the trigger that created the entry, a timestamp 74 in coordinated universal time of the time the entry was made, and one or more values 76 of a data element linked by the foreign key dependency. In the depicted instance of the shadow table 44, the SI_STATUS VALUE is the integer value stored in SI_SETTLEMENT_STATUS_ID, which is linked by the foreign key dependency 60 illustrated in FIG. 2.

It will be appreciated that in some scenarios, multiple shadow tables may be generated, based on the user input domain data tables to be monitored during a test. For example, for each detected foreign key dependency 60, the test module 42 may be configured to create a respective shadow table 44, each shadow table 44 being configured to store a respective action 70, referring table 72, timestamp 74, and value 76 of a data element linked by the foreign key dependency. Further the test module 42 may be configured to create the one or more triggers 46 of the multiple shadow tables 44 by creating triggers 46 on the domain data tables 34 that are linked via the one or more foreign key dependencies 60.

Returning to FIG. 1, after the test program 40 has completed the test on the codebase 24, and the shadow table 44 is populated with the entries 48, the process moves to the post testing phase 22, during which the output from the coverage program is saved and/or displayed to the user. To accomplish this, the coverage program 12 may include an output module 50 that may be executed on the development computer 14 during the post testing phase 22, and configured to compare the shadow table 44 and the target domain data table 34 to produce a coverage result 52, and to display the coverage result 52 via a visualization interface 54 of the graphical user interface 38 of the coverage program 12. It will be appreciated that the shadow table 44 may be sized to be joined to the target domain data table 34 without loss of data in the target domain data table 34, and the output module 50 may be configured to compare the shadow table 44 and the target domain data table 34 by joining the shadow table 44 with the target domain data table 34, to produce the coverage result 52. Alternatively, other suitable buffers, data structures, tables, or temporary data storage mechanisms may be employed by the output module to store the coverage data temporarily, for inclusion with the domain data in the coverage report.

The output module 50 and/or the test module 42 may be configured to store an output file including the coverage result 52. The output file 56 may, for example, be in XML format, and readable by the output module to display the coverage result 52 on the visualization interface of the graphical user interface 38.

Turning to FIG. 5, the visualization interface 54 of the graphical user interface 38 may be configured to display the coverage result 52 in a table format, which may include a numerical or graphic indication of a number of times the trigger was fired during the test. In the depicted embodiment, a numerical indication 84 is shown in the I_OCCURENCE column. Alternatively or in addition, a graph, icon, chart or other graphical indication may be used to indicate the number of times the subject trigger was fired.

To enable the developer to ascertain the aspects of the domain data table that may not have been adequately covered by the test, the coverage result 52 may include a graphical indication 86 of a lack of coverage for a portion of the data domain. In the illustrated embodiment, the graphical indication 86 is depicted as highlighting in rows where the numerical indication 84 is zero. A zero value indicates that no triggers were fired that would indicate coverage of the corresponding values for SI_SETTLEMENT_STATUS_ID and C_DESCRIPTION in the same row as the zero. Thus, no triggers were fired for the highlighted values such as HARD DECLINE, IMMEDIATE SETTLE DECLINE, etc., in the data domain for the data element SETTLEMENT_STATUS_TYPE, indicating that these values have not been covered by the test.

A developer may utilize the coverage results 52 in several ways. For example, the highlighted rows may be manually investigated by a developer to determine their effect, and if desired, the test program may be modified by the developer to cover one or more of the areas that were not covered in the first run of the test. Or, the highlighted rows may be programmatically communicated to the test program, and the test program may be configured to alter its test suite to cover the highlighted values.

FIG. 4 illustrates an embodiment of a method 100 to determine domain data coverage of a test of a codebase that utilizes a relational database. The method may be implemented using the hardware and software of the systems described above, or via other suitable hardware and software. At 102, the method may include receiving user input indicative of a target domain data table of the relational database to be monitored during a test of the codebase, via a graphical user interface of a coverage program. The target domain data table includes possible values for a data element utilized by the codebase and stored in the relational database. It will be appreciated that this step may be performed on a development computer.

At 104, the method may include programmatically generating a shadow table configured to receive coverage data, the size of the shadow table being compatible with the target domain data table. For example, the shadow table may be sized to be joined to the target domain data table without loss of data in the target domain data table. In some embodiments, the programmatic generation of the shadow table may include detecting one or more foreign key dependencies of the target domain data table. For each detected foreign key dependency, a respective shadow table may be created, each shadow table being configured to store an action, a referring trigger, a timestamp, and a value of a data element linked by the foreign key dependency. Further, creating the one or more triggers may include programmatically creating triggers on the tables that are linked via the one or more foreign key dependencies. It will be appreciated that the step of programmatically generating a shadow may be performed on a test computer.

At 106, the method includes creating one or more triggers on the target domain data table, the triggers being configured, upon firing, to make entries of coverage data in the shadow table. As described above, the triggers may be configured to indicate that a value in the data domain was covered by the test, and may be programmatically created on a table that includes a referring foreign key dependency to a monitored data element.

At 108, the method may include running a test on the codebase. At 110, the method may include during the test, upon firing of a trigger, writing coverage data in the shadow table indicating that the trigger was fired. It will be appreciated that the steps of creating the one or more triggers, running the test, and writing the coverage data to the showdown table may be performed on a test computer.

At 112, the method may include comparing the shadow table and the target domain data table to produce a coverage result. For example, comparing the shadow table and the target domain data table may include joining appropriate data in the shadow table with the target domain data table, to produce the coverage result, as illustrated and described above.

At 114, the method may include displaying the coverage result via the graphical user interface of the coverage program. The coverage result may be in a table format, and includes a numerical or graphic indication of a number of times the trigger was fired, as illustrated in FIG. 5. Further the coverage result may include a graphical indication of a lack of coverage for a portion of the data domain, also as illustrated in FIG. 5. It will be appreciated that comparing the shadow table and the target domain data table to produce the coverage result, and displaying the coverage result may be performed on the development computer.

The above described systems and methods may be used to efficiently determine the coverage of domain data during a test of an application program that utilizes a relational database, by enabling the user to input a data domain table to be monitored, run a test, and then view a visualization of a coverage result.

It will be appreciated that the computing devices described herein may be suitable computing devices configured to execute the programs described herein. For example, the computing devices may be a mainframe computer, personal computer, laptop computer, or other suitable computing device, and may be connected to each other via computer networks, such as a local area network or a virtual private network. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It will be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

1. A testing system to determine domain data coverage of a test of a codebase that utilizes a relational database, the testing system comprising a coverage program configured to be executed by a processor of a computing device, the coverage program including:
a setup module configured to receive user input indicative of a target domain data table of the relational database to be monitored during a test of the codebase, via a graphical user interface of a coverage program;
a test module configured to programmatically generate a shadow table configured to receive coverage data, the size of the shadow table being compatible with the target domain data table, and to create one or more triggers on the target domain data table, the triggers being configured, upon firing, to make entries of coverage data in the shadow table indicating that the trigger was fired during the test; and
an output module configured to compare the shadow table and the target domain data table to produce a coverage result, and to display the coverage result via the graphical user interface of the coverage program.

2. The testing system of claim 1, wherein the target domain data table includes possible values for a data element utilized by the codebase and stored in the relational database.

3. The testing system of claim 1,
wherein the shadow table is sized to be joined to the target domain data table without loss of data in the target domain data table; and
wherein the output module is configured to compare the shadow table and the target domain data table by joining the shadow table with the target domain data table, to produce the coverage result.

4. The testing system of claim 1, wherein the test module is configured to detect one or more foreign key dependencies of the target domain data table.

5. The testing system of claim 4, wherein, for each detected foreign key dependency, the test module is configured to create a respective shadow table, each shadow table being configured to store an action, a referring trigger, a timestamp, and a value of a data element linked by the foreign key dependency.

6. The testing system of claim 4, wherein the test module is configured to create the one or more triggers by creating triggers on the tables that are linked via the one or more foreign key dependencies.

7. The testing system of claim 1, wherein the coverage result is in a table format, and includes a numerical or graphic indication of a number of times the trigger was fired during the test.

8. The testing system of claim 1, wherein the coverage result includes a graphical indication of a lack of coverage for a portion of the data domain.

9. The testing system of claim 1,
wherein the setup module is executed on a development computer during a design phase of development of the codebase;
wherein the test module is executed on a test computer during a pre-testing phase of the development; and
wherein the output module is executed on the development computer during a post-testing phase of the development.

10. The testing system of claim 1, wherein the output module and/or the test module is configured to store an output file including the coverage results.

11. A testing method to determine domain data coverage of a test of a codebase that utilizes a relational database, the method comprising:
receiving user input indicative of a target domain data table of the relational database to be monitored during a test of the codebase, via a graphical user interface of a coverage program;
programmatically generating a shadow table configured to receive coverage data, the size of the shadow table being compatible with the target domain data table;
creating one or more triggers on the target domain data table, the triggers being configured, upon firing, to make entries of coverage data in the shadow table;
running a test on the codebase;
during the test, upon firing of a trigger, writing coverage data in the shadow table indicating that the trigger was fired;
comparing the shadow table and the target domain data table to produce a coverage result; and
displaying the coverage result via the graphical user interface of the coverage program.

12. The method of claim 11, wherein the target domain data table includes possible values for a data element utilized by the codebase and stored in the relational database.

13. The method of claim 11,
wherein the shadow table is sized to be joined to the target domain data table without loss of data in the target domain data table; and
wherein comparing the shadow table and the target domain data table includes joining the shadow table with the target domain data table, to produce the coverage result.

14. The method of claim 11, further comprising, detecting one or more foreign key dependencies of the target domain data table.

15. The method of claim 14, wherein, for each detected foreign key dependency, a respective shadow table is created, each shadow table being configured to store an action, a referring trigger, a timestamp, and a value of a data element linked by the foreign key dependency.

16. The method of claim 14, wherein creating the one or more triggers includes creating triggers on the tables that are linked via the one or more foreign key dependencies.

17. The method of claim 11, wherein the coverage result is in a table format, and includes a numerical or graphic indication of a number of times the trigger was fired.

18. The method of claim 11, wherein the coverage result includes a graphical indication of a lack of coverage for a portion of the data domain.

19. The method of claim 11, wherein receiving, comparing and displaying are performed on a development computer, and wherein generating, creating, running and writing are performed on a test computer.

20. A testing method to determine domain data coverage of a test of a codebase that utilizes a relational database, the method comprising:
receiving user input indicative of a target domain data table of the relational database to be monitored during a test of the codebase, via a graphical user interface of a coverage program;
programmatically creating one or more triggers on the target domain data table, the triggers being configured, upon firing, to generate coverage data indicating that the trigger was fired;
running a test on the codebase;
during the test, upon firing of a trigger, writing coverage data indicating that the trigger was fired in a coverage result table; and
displaying the coverage result table via the graphical user interface of the coverage program.
